(19) United States
(12) Patent Application Publication
(10) Pub. No.: US 2010/0268453 A1
(43) Pub. Date: Oct. 21, 2010

(54) NAVIGATION DEVICE

(75) Inventors: Kinya Otani, Osaka (JP); Naoki Hirose, Osaka (JP); Yuta Taguchi, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi, Osaka (JP)

(21) Appl. No.: 12/744,184

(22) PCT Filed: Nov. 19, 2008
(86) PCT No.: PCT/JP2008/070981

§ 371 Date: May 21, 2010

(30) Foreign Application Priority Data
Nov. 26, 2007 (JP) 2007-304142

(51) Int. Cl. G01C 21/36

(52) U.S. Cl. 701/201

(57) ABSTRACT

A navigation device is provided with which output of a guidance voice is completed at an appropriate timing with respect to a reference point related to output of the guidance voice. The navigation device of the present invention includes position locating means 9 for locating a position of a vehicle, speed measurement means 13 for measuring a speed of the vehicle, audio output means 15 and 17 for outputting a guidance voice related to a guide point N on a guidance route leading to a destination, and a control means 1 for controlling output of the guidance voice by using as reference a reference point obtained by returning along the guidance route from the guide point by a prescribed reference distance. The control means 1, when the vehicle reaches an utterance start point obtained by returning along the guidance route from the guide point by an utterance start distance, causes the audio output means 15 and 17 to output the guidance voice. The utterance start distance is longer than the reference distance, and increases as an utterance time that is the duration of the guidance voice increases, and as the vehicle speed measured at the speed measurement point for the reference point increases.

### TECHNICAL FIELD

The present invention relates to a navigation device that guides the travel of a vehicle along a guidance route by issuing a guidance voice notifying the driver of various information relating to the travel of the vehicle.

### BACKGROUND ART

Navigation devices mounted in a vehicle show a map around the current position of the vehicle together with a guidance route, and when the vehicle approaches a guide point such as an intersection or a fork in the road, outputs a guidance voice notifying the driver of the travel direction of the vehicle at the guide point, the travel distance to the guide point, or the like, thereby guiding the travel of the vehicle along guidance route.

For audio-based guidance to function effectively, navigation devices need to output a guidance voice at an appropriate timing. For example, JP 2001-241962A discloses a navigation device that changes the interval between reference points that serve as a reference for the output timing of the guidance voice depending on the vehicle speed. With this navigation device, the interval between reference points is increased when the vehicle speed is fast, in an attempt to match the output timing of audio guidance with what the driver is experiencing.

### DISCLOSURE OF INVENTION

### Problems to be Solved by the Invention

With typical navigation devices including the navigation device disclosed in JP 2001-241962A, when the vehicle is determined to have reached a reference point that is located a prescribed reference distance before a guide point, a guidance voice for that guide point is output. The content of the guidance voice often includes a reference distance. For example, when the vehicle reaches a reference point that is located 400 m short of an intersection (guide point) where the vehicle is to turn left, the guidance voice, “Turn left in 400 meters”, is output.

It is preferable that a navigation device outputs such a guidance voice at an appropriate timing relative to a set reference point (that is, relative to a point in time when the vehicle passes through the reference point). In particular, in a case of notifying the driver with the use of a guidance voice of the distance between the reference point and a guide point, i.e., the reference distance, it is preferable that the vehicle is traveling through a point as close to the reference point as possible at the point in time when output of the guidance voice is completed. Taking the above case as an example, it is preferable that output of the guidance voice, “Turn left in 400 meters”, completes at the point in time when the vehicle passes through a point as close to the reference point as possible (more preferably, the reference point itself) that is located 400 m short of the intersection where the vehicle is to turn left.

However, with conventional navigation devices, the location of the vehicle upon completion of the output of the guidance voice varies relative to the reference point depending on the vehicle speed when passing through the reference point. For example, consider the case in which the vehicle passes through a reference point at 20 km/h and the case in which the vehicle passes through the reference point at 60 km/h, assuming that the output of a guidance voice starts from the point in time when the vehicle has passed through the reference point. When the same guidance voice is output in the two cases, the distance between the reference point and the vehicle in the latter case will be three times that in the former case at the point in time when the output of the guidance voice is completed.

Furthermore, with conventional navigation devices, the location of a vehicle upon completion of the output of the guidance voice varies relative to the reference point depending on the duration of the guidance voice. For example, consider the case in which the guidance voice has a duration of three seconds and the case in which the guidance voice has a duration of nine seconds, assuming that the output of the guidance voice starts from the point in time when a vehicle has passed through a reference point. When the vehicle speed is the same in the two cases, the distance between the reference point and the vehicle in the latter case is three times that in the former case at the point in time when the output of the guidance voice is completed.

In this manner, with conventional navigation devices, the point in time when the output of the guidance voice completes varies relative to the point in time when the vehicle passes through the reference point, depending on the vehicle speed and the duration of the guidance voice. For this reason, when the distance between a reference point and a guide point is notified with a guidance voice, a problem may occur in which a vehicle is located in a position far removed from the reference point at the point in time when the guidance voice output is completed, and the distance notified by the guidance voice and the actual distance do not match. Also, with navigation devices that display on a display device a travel distance from the current vehicle position to the guide point, a gap occurs between the distance guided with the guidance voice and the travel distance displayed on the display device at the point in time when the guidance voice output is completed.

The present invention solves the foregoing problems, and provides a navigation device in which the output of a guidance voice completes at an appropriate timing relative to a reference point or a reference distance that is set in relation to the output of the guidance voice.

### Means for Solving the Problems

A navigation device of the present invention is a navigation device including position locating means for locating a position of a vehicle, speed measurement means for measuring a speed of the vehicle, audio output means for outputting a guidance voice related to a guide point on a guidance route leading to a destination, and control means for controlling output of the guidance voice by using as reference a reference point obtained by returning along the guidance route from the guide point by a prescribed reference distance, wherein the control means calculates an utterance start distance when the vehicle reaches a speed measurement point on the guidance route set with respect to the reference point, and causes the audio output means to output the guidance voice when the vehicle reaches an utterance start point obtained by returning along the guidance route from the guide point by the utterance start distance, and the utterance start distance is longer than the reference distance, and increases as a duration of the guidance voice increases, and as the vehicle speed at the speed measurement point increases.

With the navigation device of the present invention, the utterance start distance is determined by an operation that includes adding the reference distance to a product of the duration of the guidance voice and the vehicle speed at the speed measurement point. It is preferable that the utterance start distance is a value obtained by adding the reference distance to a product of a sum of a prescribed adjustment value and the duration of the guidance voice and the vehicle speed at the speed measurement point. It is preferable that the reference distance in a case where the reference point is on an expressway is longer than the reference distance in a case where the reference point is on a road other than an expressway.

With the navigation device of the present invention, the control means, in a case where the vehicle speed at the speed measurement point is faster than a prescribed reference speed, causes the audio output means to output the guidance voice at the speed measurement point. It is preferable that the reference speed in a case where the speed measurement point is on an expressway is faster than the reference speed in a case where the speed measurement point is on a road other than an expressway. It is preferable that the control means, in a case where the utterance start distance is equal to or longer than a distance from the speed measurement point to the guide point along the guidance route, causes the audio output means to output the guidance voice at the speed measurement point.

A navigation device of the present invention is a navigation device including position locating means for locating a position of a vehicle, speed measurement means for measuring a speed of the vehicle, audio output means for outputting one or more guidance voices for a guide point on a guidance route leading from a start point to a destination, and control means for controlling output of the one or more guidance voices based on the position of the vehicle and the speed of the vehicle, wherein the one or more guidance voices are respectively related to one or more reference points on the side of the start point relative to the guide point on the guidance route, one or more speed measurement points are respectively set for the one or more reference points, on the side of the start point relative to the guide point, the control means, when the vehicle reaches each of the one or more speed measurement points, calculates an utterance start distance with use of the vehicle speed measured at the speed measurement point, and when the vehicle reaches an utterance start point obtained by returning along the guidance route from the guide point by the utterance start distance, causes the audio output means to output the guidance voice related to the reference point corresponding to the speed measurement point, and the utterance start distance is longer than the reference distance from the reference point corresponding to the speed measurement point that the vehicle has reached to the guide point along the guidance route, and increases as a duration of the guidance voice related to the reference point increases and as the measured vehicle speed increases.

Also, with the navigation device of the present invention, except for a case in which the utterance start point is an utterance start point that is nearest to the guide point, a guidance voice including notification of the reference distance of the reference point corresponding to the speed measurement point where the vehicle speed used in calculating the utterance start distance was measured is output at the utterance start point. It is preferable that the reference distance of each of the one or more reference points differs depending on whether or not the reference point is on an expressway, and the reference distance of the reference point if located on an expressway is longer than the reference distance of the reference point if located on a road other than an expressway.

Also, with the navigation device of the present invention, the control means, in a case where the vehicle speed measured at one of the one or more speed measurement points is faster than a prescribed reference speed, causes the audio output means to output the guidance voice related to the reference point corresponding to the speed measurement point at the speed measurement point. It is preferable that the reference speed is not the same for all of the one or more speed measurement points, and the reference speed for a speed measurement point that is nearest to the guide point is the slowest. It is preferable that the reference speed, for each of the one or more speed measurement points, differs depending on whether or not the speed measurement point is on an expressway, and the reference speed in the case where the speed measurement point is on an expressway is faster than the reference speed in the case where the speed measurement point is on a road other than an expressway.

### EFFECT OF THE INVENTION

In the present invention, a guidance voice is output when a vehicle reaches an utterance start point that is located short of a reference point on a guidance route, and an utterance start distance, which is the distance from an utterance start point to a guide point, increases as the utterance duration of the guidance voice increases or as vehicle speed measured at a speed measurement point increases. As a result, the utterance of the guidance voice ends without significantly deviating from the point in time when the vehicle passes through the reference point. In the case where the distance from the reference point to the guide point is notified with a guidance voice, a time lag between the point in time when the guidance voice ends and the point in time when the vehicle passes through the reference point is small, which makes the present invention more effective. Furthermore, by employing the present invention, with a navigation device in which the travel distance from a current vehicle position to a guide point is displayed, the difference between the travel distance displayed at the point in time when the guidance voice ends and the distance notified with the guidance voice will be small.

### BRIEF DESCRIPTION OF THE DRAWINGS

FIG. 1 is a block diagram of a navigation device of an embodiment of the present invention.

FIG. 2 is a flowchart illustrating a guide operation that the navigation device of the embodiment of the present invention performs.

FIG. 3 is a diagram illustrating an exemplary guidance route and nodes and links forming the guidance route.

FIG. 4 illustrates utterance reference points, utterance start points where a guidance voice is output, and speed measurement points where a vehicle speed is measured that are set by a navigation device of an embodiment of the present invention.

FIG. 5 is a flowchart illustrating a detailed process for setting the utterance reference points that a navigation device of an embodiment of the present invention performs.

FIG. 6 is an example of an utterance reference point list prepared and stored by a navigation device of an embodiment of the present invention.

FIG. 7 is an example of a voice type table stored in a navigation device of an embodiment of the present invention.

FIG. 8 illustrates a condition in which a point obtained by advancing a prescribed distance from a guide point that precedes another guide point is set as the speed measurement point.

FIG. 9 is a flowchart illustrating a detailed process for setting the speed measurement points that a navigation device of an embodiment of the present invention performs.

FIG. 10 is a flowchart illustrating an audio guidance process that a navigation device of an embodiment of the present invention performs.

### EXPLANATION OF REFERENCE NUMBERS

(1) Control portion
(9) GPS receiver
(13) Vehicle speed sensor
(19) Audio output portion
(21) Speaker
(23) Recording Medium
(29) Voice element data file
N Guide point
R1 to R3 First to third reference points
PC1 to PC3 First to third utterance start points
PV1 to PV3 First to third speed measurement points

### BEST MODE FOR CARRYING OUT THE INVENTION

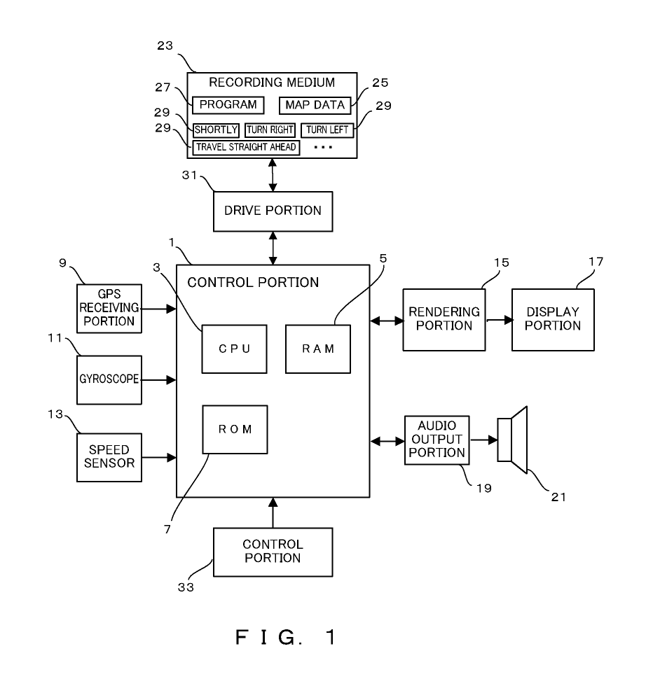

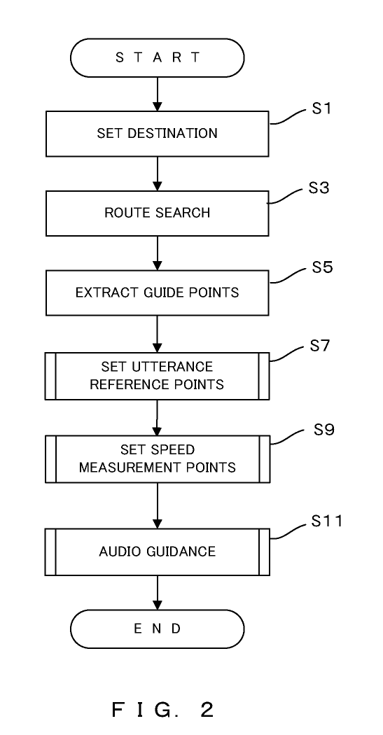

Hereinafter, the present invention will be described with reference to the attached drawings. FIG. 1 is a block diagram of an in-vehicle navigation device according to an embodiment of the present invention. A control portion (1) performs overall control of the navigation device and executes various processes and operations for executing functions of the navigation device. The control portion (1) is a microcomputer for example, and includes a CPU (3) that performs various operations and executes various programs including a program describing a guide operation described below with reference to FIG. 2, a RAM (5) that temporarily stores programs executed by the CPU (3) or data to be used by the CPU (3), and a ROM (7) that stores a boot program or the like executed when the device is powered on.

A GPS receiver (9) is constituted by a GPS LSI for example, and includes a receiving circuit for receiving GPS signals from GPS satellites via a GPS antenna (not shown), a logic circuit that processes received GPS signals so as to demodulate data to be used for a position operation, and the like. Data demodulated by the GPS receiver (9) is transmitted to the control portion (1). A gyroscope (11) detects the azimuth of the vehicle and transmits azimuth data to the control portion (1). A speed sensor (13) detects the vehicle speed and transmits speed data to the control portion (1). The control portion (1) uses data demodulated by the GPS receiver (9) to calculate the current vehicle position, and uses data from the gyroscope (11) and the speed sensor (13) respectively to specify the azimuth and the speed of the vehicle. Note that data from the gyroscope (11) and the speed sensor (13) may also be used to calculate the current vehicle position, in addition to the data from the GPS receiver (9).

A rendering portion (15) generates image data for the screen displayed on a display portion (17) based on commands, rendering data or the like transmitted from the control portion (1). Screens displayed on the display portion (17) include, for example, a guidance screen including a map around the vehicle, a menu screen, various setting screens, and various search screens. The rendering portion (15) is, for example, constituted by a rendering LSI, and includes a graphics processor that executes rendering processing, a graphics memory that stores image data generated by the rendering processing, and a display controller that generates image signals to be transmitted to the display portion (17) based on the image data stored in the graphics memory. A liquid crystal display device, for example, is used as the display portion (17).

An audio output portion (19) is constituted by a voice output LSI including a DAC (digital-to-analog converter), a low-pass filter, an amplifier and the like, and generates voice signals for guidance voice output by the navigation device based on the commands and voice data transmitted from the control portion (1). The voice signals generated by the audio output portion (19) are reproduced with a speaker (21).

A recording medium (23) is a hard disk, memory card, DVD or CD-ROM, for example, and stores map data (25), and a program (27) describing procedures for the guide operation and other operations of the in-vehicle navigation device (the program (27) may be stored in the ROM (7) of the control portion (1), or other storage means). The recording medium (23) also stores various voice element data files (29) corresponding to various audio elements that constitute guidance voices. The data of the voice element data file (29) is PCM data for example, and more specifically, data in WAV format. The map data (25), the program (27) and the voice element data files (29) are read out via a drive portion (31) and transmitted to the control portion (1).

The map data (25) is managed in predetermined geographic regions (e.g., rectangular regions), and partially read out by the control portion (1) as required. The map data (25) includes, for each of the regions, road data relating to nodes and links that describes the road network, geographical data relating to the road shape, terrain features or the like, and character/symbol data relating to state names, prefecture names, municipality names, road names and the like. The road data includes, for each node, information on longitude and latitude, attributes such as three-way intersection or crossroads, connecting links, and so on, and also includes, for each link, information on road classifications such as expressway or open road, road names (i.e., national road Route 1), the length and the azimuth of links, and so on. The road data is used for route searches or description of the guidance route, and geographical data and the character/symbol data are used for rendering maps.

The operation portion (33) is constituted by hardware keys such as a power key, a touch panel provided in the display area of the display portion (17), and a control microcomputer that controls the hardware key and the touch panel (all of which are not shown). The operation portion (33) may further include a remote controller.

FIG. 2 shows a flowchart illustrating the guide operation performed by the navigation device of the present embodiment. The program (27) describing this operation is loaded to the RAM (5) of the control portion (1) from the recording medium (23) and executed by the CPU (3) of the control portion (1). The control portion (1) first performs processing for setting a destination (S1). For example, when an instruction is given by the user via the menu screen (not shown), a screen for a destination search (not shown) is displayed on the display portion (17). After the user has input search conditions on the destination search screen, a search for the place that satisfies the conditions is carried out, and the retrieved one or more places are presented to the user. Then, in response to an instruction or selection by the user, the retrieved place or a place selected from among the retrieved places is set as the destination. The map data (25) stored in the recording medium (23) also includes a database used to search for places, with name, address, telephone number or the like as a search condition. The control portion (1) performs the search with reference to the database, and stores in the RAM (5) the information on the place set as the destination such as the latitude and longitude, name and the like.

After the destination is set, the control portion (1) executes a route search so that the guidance route is determined (S3). In step S3, the control portion (1) calculates the current vehicle position based on the data from the GPS receiver (9) and the like, and executes the route search from the calculated current position as the start point to the set destination. The control portion (1) carries out the route search with reference to the road data of the map data (25) in the recording medium (23), and stores information on the nodes and links forming the guidance route in the RAM (5) as guidance route information. For example, a route search is carried out with the Dijkstra Method and out of the routes from the node corresponding to the current position (for example, the nearest node to the current position) to the node corresponding to the destination (for example, the nearest node to the destination), the route having the smallest cost in terms of travel time or travel distance is determined as the guidance route.

Once the guidance route is determined as a result of the route search, the control portion (1) extracts all guide points where a guidance voice should be output from the guidance route information that has been stored, and stores each of the extracted guide points in association with the various guide items, such as the corresponding travel direction of the vehicle at each guide point, the type of the guide point, or the like (S5). For example, in step S5, the control portion (1) determines, for each node included in the guidance route, whether or not there is any link, other than the exit link, that can be exited to from the node after traveling along the approach link. The “approach link” used herein refers to a link that exists on the guidance route, and that ends at the node in question, and the “exit link” used herein refers to a link that exists on the guidance route, and that starts from the node in question. Then, the control portion (1) determines, for each node having a link (other than the exit link) that can be exited to, whether the vehicle will naturally follow the approach link and the exit link, based on the azimuths or the like associated with the approach link, the exit link and the link that can be exited to (in other words, whether or not to guide the travel direction of the vehicle). Furthermore, the control portion (1) specifies, for each node where the vehicle will not naturally follow the approach link and the exit link, the travel direction of the vehicle based on the azimuths or the like associated with the approach link, the exit link, and the links that can be exited to, and stores such nodes as guide points together with various information including the travel direction. The travel directions of the vehicle include left, diagonally left, right, diagonally right, U-turn, straight ahead, and the like. For example, a node that corresponds to a turnoff on an expressway, where the vehicle will exit the expressway if it travels straight ahead along the guidance route, is extracted as a guide point, while setting the travel direction of the vehicle as traveling straight ahead. In addition, in step S5, nodes corresponding to the destination or stopover points and nodes corresponding to special points such as ferry boarding places are also extracted as guide points. For these guide points, guidance voices for guiding the travel distance to or arrival at such points are output in the guide operation.

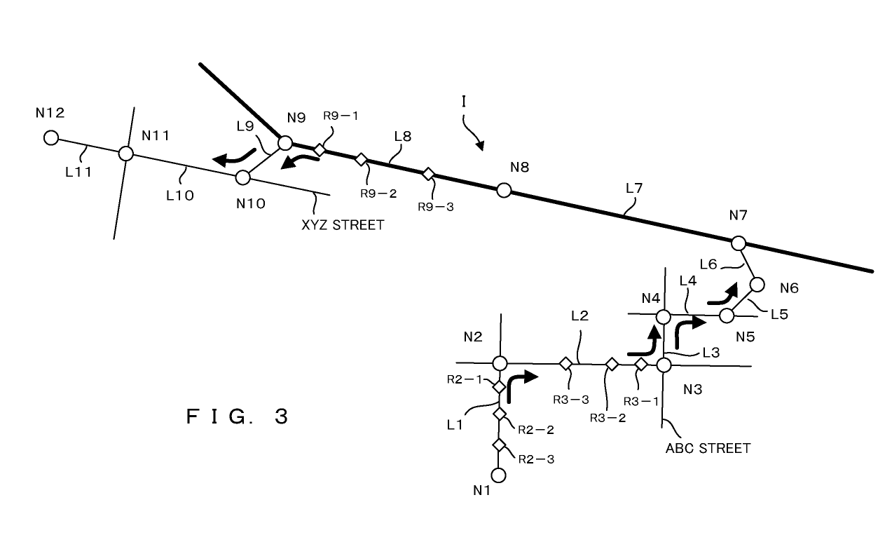

For example, it is assumed that a guidance route I as illustrated in FIG. 3 is obtained in step S3. The guidance route I is described with nodes from node N1 that corresponds to the start point to node N12 that corresponds to the destination, and links from link L1 to link L11 present between node N1 and node N12. Links L7 and L8 correspond to an expressway, while links L1 to L4 and links L10 and L11 correspond to open roads other than an expressway, such as city roads. Links L5, L6 and L9 correspond to an access road between an expressway and an open road. Nodes corresponding to the guide points where audio-based guidance is provided are node N2 that corresponds to an intersection where the vehicle is to turn right, node N3 that corresponds to an intersection where the vehicle is to turn left, node N4 that corresponds to an intersection where the vehicle is to turn right, node N5 that corresponds to a fork in the road where the vehicle is to turn left to enter an access road to an expressway, node N9 that corresponds to a turnoff where the vehicle is to turn left to enter an access road to an open road, node N10 that corresponds to an intersection where the vehicle is to turn right, and node N12 that corresponds to the destination. These nodes are extracted as the guide points in step S5.

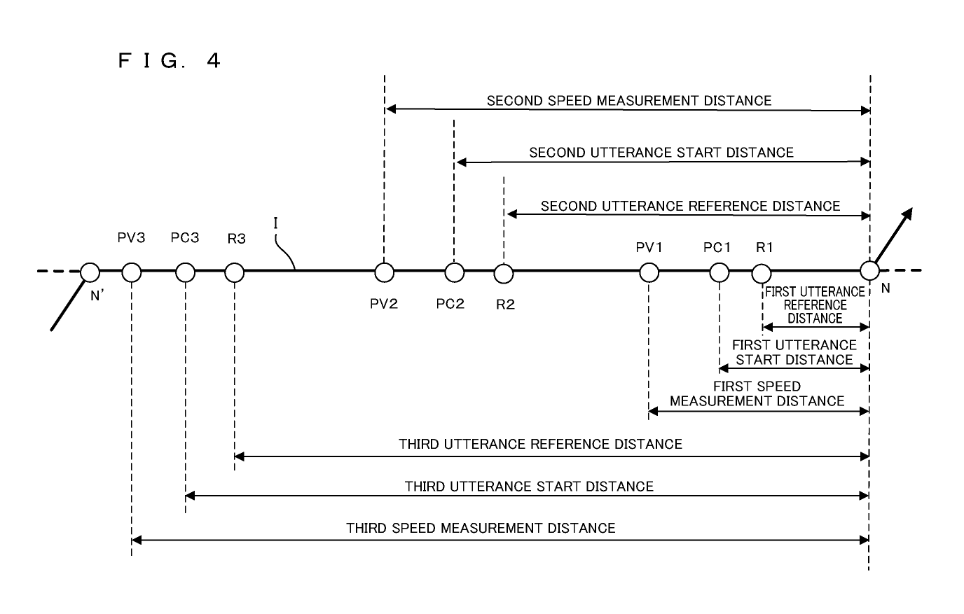

After step S5, the control portion (1) performs a process for setting one or more utterance reference points for each of the extracted guide points (S7). The control portion (1) performs a process for setting speed measurement points (S9) for each of the utterance reference points set in step S7, and thereafter performs audio guidance with the travel of the vehicle (S11). Details of steps S7 to S11 will be described later. FIG. 4 illustrates utterance reference points (R1 to R3) set for a guide point N, and speed measurement points (PV1 to PV3) respectively set for the utterance reference points. Utterance start points (PC1 to PC3) at which a guidance voice is output are also shown in FIG. 4.

The utterance reference points are described first. In the present embodiment, a guidance voice is output three times for a single guide point, and therefore three utterance reference points are set between the guide point N and a guide point N′ (immediately preceding guide point), which is located on the side of start point relative to the guide point N. A first utterance reference point R1 is a point set by returning along the guidance route I from the guide point (or a node corresponding to the guide point) N by a first utterance reference distance, a second utterance reference point R2 is a point set by returning along the guidance route I from the guide point N by a second utterance reference distance, and a third utterance reference point R3 is a point set by returning along the guidance route I from the guide point N by a third utterance reference distance. Note that the first utterance reference distance<the second utterance reference distance<the third utterance reference distance. The navigation device of the present embodiment controls the output timing of the guidance voices with reference to the first to third utterance reference points R1 to R3.

The first to third utterance reference distances differ depending on whether each of the first to third utterance reference points R1 to R3 is on an expressway, in other words, whether the section on the guidance route from the guide point N′ to the guide point N is on an expressway or not. The first to third utterance reference distances in the case where the first to third utterance reference points R1 to R3 are on the expressway are longer than the first to third utterance reference distances in the case where the first to third utterance reference points R1 to R3 are not on the expressway. In the present embodiment, when the first to third utterance reference points R1 to R3 are not on an expressway, the first utterance reference distance is set to 50 m, the second utterance reference distance to 400 m, and the third utterance reference distance to 1,000 m. Furthermore, in the present embodiment, when the first to third utterance reference points R1 to R3 are on the expressway, the first utterance reference distance is set to 120 m, the second utterance reference distance to 1,000 m, and the third utterance reference distance to 2,000 m. These setting values of the first to third utterance reference distances are, for example, stored in the ROM (7) of the control portion (1).

In this manner, in principle, three utterance reference points are set between adjacent guide points in the present embodiment. In the case where the distance between adjacent guide points (along the guidance route) is short, it may not be practically possible to set all three utterance reference points. The present embodiment is configured such that in the case where the distance between adjacent guide points is short, the number of set utterance reference points is reduced so that the number of utterances between adjacent guide points is reduced. Also, when the distance between adjacent guide points is shorter than the first utterance reference distance, it is impossible even to set the first utterance reference point R1 shown in FIG. 4, but from the standpoint of the function of the navigation device, it is required to utter a guidance voice at least once with respect to a certain guide point. The process for setting utterance reference points in step S7 in FIG. 2 is based on these circumstances.

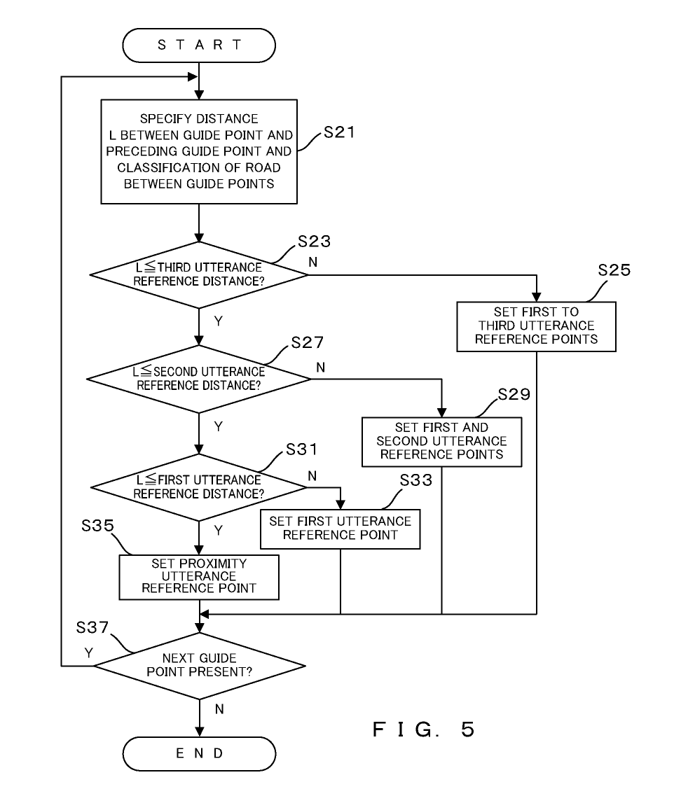

FIG. 5 is a flowchart illustrating a detailed process for setting utterance reference points in step S7. In this process, utterance reference points are set for the guide points on the guidance route in order from the start point to the destination. The control portion (1) obtains a distance L (along the guidance route) between a guide point for which utterance reference points are to be specified and a guide point that precedes that guide point, and specifies the road classification of the section between these adjacent guide points (S21). The distance L between the guide points and the road classification are determined based on link lengths, road attributes and the like included in the guidance route information obtained in step S3. Note that with respect to the first guide point, the distance between the start point and the first guide point and the road attribute thereof are specified.

After step S21, the control portion (1) determines whether or not the distance L between the guide points is equal to or shorter than the third utterance reference distance (S23). In step S23, the third utterance reference distance in accordance with the road classification specified in step S21 is selected (2,000 m in the case of the road classification being expressway, and 1,000 m in the case of the road classification being other than expressway), and the selected third utterance reference distance is compared with the distance L. In the case where the distance L between the guide points exceeds the third utterance reference distance, the control portion (1) performs a process for setting the first to third utterance reference points with respect to a target guide point (S25). Set utterance reference points are added to an utterance reference point list stored in the RAM (5). The utterance reference point list will be described later in detail.

In the case where it is determined in the step S23 that the distance L between the guide points is equal to or shorter than third utterance reference distance, the control portion (1) determines whether the distance L between the guide points is equal to or shorter than the second utterance reference distance (S27). In the case where the distance L between the guide points exceeds the second utterance reference distance, the control portion (1) performs a process for setting the first and second utterance reference points for the target guide point (S29). In the case where it is determined in the step S29 that the distance L between the guide point is equal to or shorter than the second utterance reference distance, the control portion (1) determines whether or not the distance L between the guide points is equal to or shorter than the first utterance reference distance (S31). In the case where the distance L between the guide points exceeds the first utterance reference distance, the control portion (1) performs a process for setting the first utterance reference point with respect to the target guide point (S33). Note that in step S27, a second utterance reference distance in accordance with the road classification specified in step S21 is selected (1,000 m in the case of the road classification being expressway, and 400 m in the case of the road classification being other than expressway), and the selected second utterance reference distance is compared with the distance L. In step S31, a first utterance reference distance in accordance with the road classification specified in step S21 is selected (120 m in the case of the road classification being expressway, and 50 m in the case of the road classification being other than expressway), and the selected first utterance reference distance is compared with the distance L.

In the case where it is determined in step S31 that the distance L between the guide points is equal to or shorter than the first utterance reference distance, the control portion (1) performs a process for setting a proximity utterance reference point for a target guide point (S35). Step S35 is a process for perfunctorily setting, in the case where the distance L between the guide points is extremely short, an utterance reference point for a target guide point. In the present embodiment, the guide point preceding the target guide point is set as the proximity utterance reference point. Also, as described later, the proximity utterance reference point is characterized by serving as the utterance start point. Note that a point obtained by advancing a prescribed distance (for example, 10 to 30 m) along the guidance route from the preceding guide point may be set as the proximity utterance reference point. After step S25, 29, 33 or 35, the control portion (1) determines based on the result in step S5 whether or not there is a next guide point for which the utterance reference points are to be set (S37), and if there is a next guide point, processing in step S21 onward is repeatedly performed on that guide point. When the utterance reference points have been set for the last guide point (destination), it is determined in step S37 that there are no guide points left, and the process for setting the utterance reference points in step S7 ends.

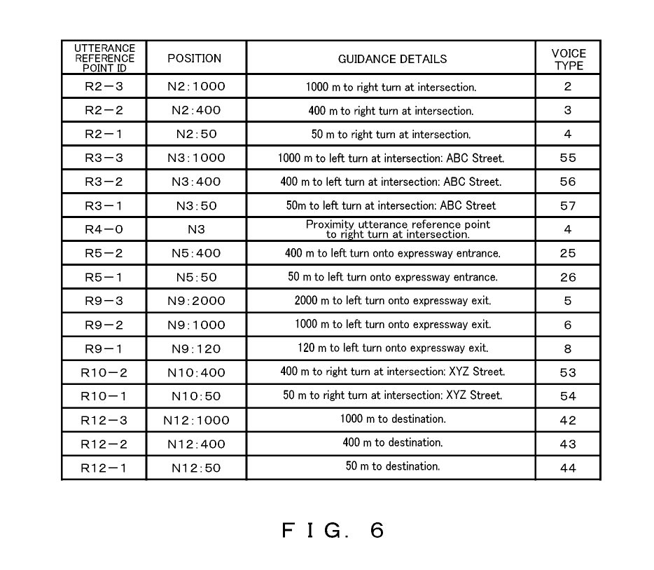

In the case of the guidance route I illustrated in FIG. 3, when the utterance reference points have been set by the control portion (1) for each node extracted as a guide point, as a result of step S7, an utterance reference point list, as shown in FIG. 6 for example, is stored in the control portion (1). The utterance reference point list includes ID numbers of utterance reference points, positions relative to corresponding guide points, guidance details, and numbers indicating the guidance voice type. For example, the fact that the utterance reference point with the ID number “R2-3” (although the ID number may simply be a numerical value, for the sake of description, the fact that this utterance reference point is the third utterance reference point of node N2 is represented with the ID number, with this use of the ID numbers also applying to the other utterance reference points.) is 1,000 m short of node N2 is described as “N2:1000”. Since node N2 is an intersection where the vehicle is to turn right, the fact that the utterance reference point relates to guiding a right turn at an intersection 1000 m short of the turn is stipulated as “1000 m to right turn at intersection”. “2” is designated as the voice type of the guidance voice for providing this guidance. Note that in the illustrated guidance route I, since the distance between node N3 and node N4 is equal to or shorter than the first utterance reference distance, node N3 is set as the proximity utterance reference point (ID number: R4-0) corresponding to node N4.

The control portion (1) stores a voice type table that provides the utterance details of each voice type. As described above, in principle, in the present embodiment, a guidance voice is output three times for a single guide point, with reference to the first to third utterance reference points. The details of the guidance voices for these three times may be the same, although they preferably are different for each of the first to third utterance reference points. In the present embodiment, the guidance voice output related to the second and third utterance reference points notifies the driver of the second and third utterance reference distances, respectively. Since the guidance voice related to the first utterance reference point is output in a situation in which the vehicle is near a guide point, it is preferable to provide a notice that the vehicle will reach the guide point soon, rather than the notification of the first utterance reference distance. In the present invention, the number of the guidance voices output for a single guide point, namely, the number of the utterance reference points set for a single guide point is not particularly limited. Except for the guidance voice related to the nearest utterance reference point to the guide point, the output guidance voice preferably includes notification of the utterance reference distance.

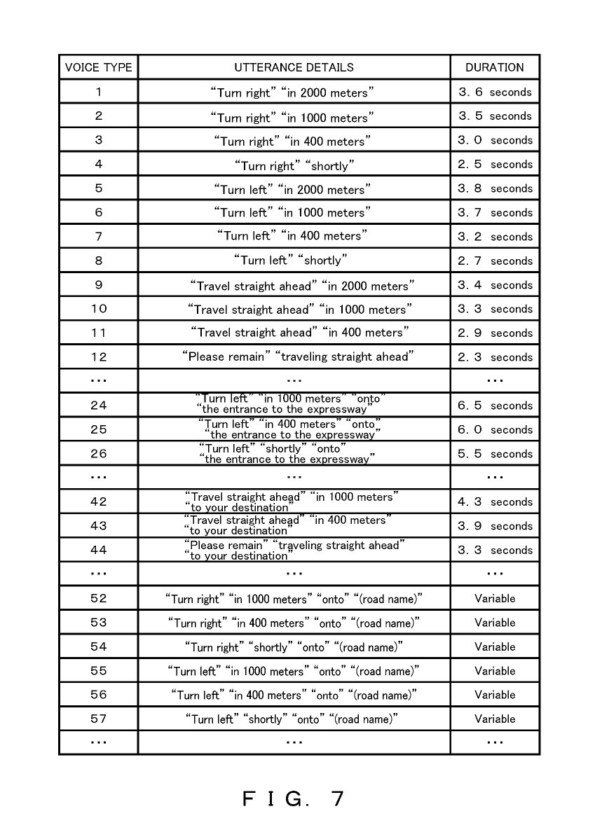

FIG. 7 illustrates an exemplary voice type table. For example, the utterance details of the guidance voice of the voice type 2 is “Turn right” “in 1000 meters”, which indicates that the guidance voice is constituted by combining two voice elements, “Turn right” and “in 1000 meters”. The voice element data files (29) of various voice elements constituting a guidance voice, that is, the voice element data file (29) of voice elements such as “in 2000 meters”, “in 1000 meters”, “Turn right”, “Turn left”, for example, are stored in the recording medium (23), as described above. The control portion (1) refers to the voice type table when outputting a guidance voice, loads necessary voice element data files (29) from the recording medium (23), composes the loaded voice element data files (29) to generate voice data for the guidance voice, and stores the generated voice data in the RAM (5). Note that while in FIG. 7, for the sake of description, utterance details are expressed as “Turn right”, “in 1000 meters” for example, actually, the utterance details are specified by the names of the voice element data files (29) for these voice elements.

The navigation device of the present embodiment, in the case where the name of a road that a vehicle is to travel on after passing through the guide point is included in the road data, outputs a corresponding guidance voice together with the name of that road. The control portion (1) determines, for each guide point, whether or not the road name is included in the link information corresponding to the road the vehicle is to travel on after passing through the guide point. When the road name is included, the name is included in the guidance details of the utterance reference point list illustrated in FIG. 6. In the guidance route I illustrated in FIG. 3, the road name of link L3 is “ABC Street”, and the road name of links L10 and L11 is “XYZ Street”, and these names are included in the guidance details for the utterance reference points that correspond to nodes N3 and N10 in the utterance reference point list in FIG. 6.

For example, in the voice type table in FIG. 7, the utterance details of the guidance voice of the voice type “52” are “Turn right”, “in 1000 meters”, “onto”, and “(road name)”, which indicate that the guidance voice is constituted by combining four voice elements, “Turn right”, “in 1000 meters”, “onto”, and “(road name)”. Here, the voice element “(road name)” is the name of the road that the vehicle is to travel on after passing through the guide point, and road names are entered according the specific cases. In the present embodiment, road names designated in the utterance reference point list are entered. In the utterance reference point list in FIG. 6, the voice type of the (third) utterance reference point R3-3 corresponding to node N3, which is the guide point where the vehicle turns left to join “ABC Street”, is “55”, and in the voice type table in FIG. 7, the utterance details of the voice type “55” are “Turn right”, “in 1000 meters”, “onto”, “(road name)”. Since the guidance details of the utterance reference point R3-3 in the utterance reference point list in FIG. 6 include “ABC Street”, “ABC Street” is entered to the voice element “(road name)”. Note that since no (specific or unique) road name is included in the road data with respect to links L2 and L4 of the guidance route I illustrated in FIG. 3, in the utterance reference point list in FIG. 6, the voice type of the guidance voices for the utterance reference points related to nodes N2, N4 or the like serving as the guide point is “2”, “3” or “4” without including the voice element “(road name”).

The voice element data file corresponding to the voice element “(road name)” is not stored in the recording medium (23). The reason being that since there are numerous road names included in the road data, it is not realistic in terms of recording capacity to generate voice element data files for the road names and store the generated files in the recording medium (23). With respect to the guidance voices including a road name, such as the voice types “52 or “55”, the control portion (1) generates the voice element data corresponding to the voice element “(road name)” as appropriate, based on the road name included in the utterance reference point list, and generates voice data for the guidance voice by composing the generated voice element data with the data of other voice element data files (29) stored in the recording medium (23).

In the voice type table illustrated in FIG. 7, for the sake of facilitating understanding of the present invention, the duration of the guidance voice is also indicated. For example, the duration of the guidance voice of the voice type “1”, “Turn right in 2000 meters” (utterance time from the start to the end of utterance) is 3.6 seconds. As understood from FIG. 6, the utterance time differs depending on the details of the guidance voice, and furthermore, the utterance time of the guidance voice including “(road name)” such as the voice type “52” varies depending on the road name to be guided.

The navigation device of the present invention, unlike conventional navigation devices, does not output (utter) a guidance voice by using as a trigger the arrival of the vehicle at the utterance reference point, but performs control such that the output of a guidance voice completes at the point in time when the vehicle reaches the utterance reference point. In order to achieve this feature, a navigation device of the present embodiment sets a speed measurement point and an utterance start point for each utterance reference point. In the example shown in FIG. 4, the first to third utterance start points PC1 to PC3 and the first to third speed measurement points PV1 to PV3 are set for the first to third utterance reference points R1 to R3, respectively. The speed measurement point is a point on the guidance route where the vehicle speed is measured, and similarly to the utterance reference point, can be specified based on the guide point, the distance along the guidance route from the speed measurement point to the guide point (speed measurement distance), and the guidance route information. The utterance start point is a point on the guidance route where the output of a guidance voice is started, and can be specified based on the guide point, the distance along the guidance route from the utterance start point to the guide point (utterance start distance), and the guidance route information. The utterance start distance is determined with the use of the vehicle speed measured at a corresponding speed measurement point and the duration of the guidance voice to be output. Note that the utterance start point and the speed measurement point are not set for the proximity utterance reference point, and the output of the guidance voice is started when the vehicle reaches the proximity utterance reference point.

With the present embodiment, the speed measurement distance between each speed measurement point and the corresponding guide point is determined by the following equation (1).

Speed Measurement Distance=Utterance Reference Distance+(Average Voice Utterance Time+Utterance Preparation Time)×Maximum Vehicle Speed Equation (1)

The utterance reference distance in equation (1) is an utterance reference distance at the utterance reference point corresponding to the speed measurement point. The average voice utterance time in equation (1) is a value corresponding to an average value of the durations of various guidance voices (utterance time). The value of the average voice utterance time is not required to be a precise average value obtained by considering all guidance voices that the navigation device of the present embodiment can output, and rather may be an average value obtained for several typical guidance voices (by setting a rough average value as regards road names). In the present embodiment, the average voice utterance time is set to, for example, about five seconds. The average voice utterance time may vary depending on the classification of the utterance reference distances. The duration of the guidance voice output in relation to the first reference point is generally shorter than the duration of the guidance voice output in relation to the second and third utterance reference points, and therefore the average voice utterance time in the case where the first utterance reference distance is substituted into the equation (1) may be shorter than the average voice utterance time in the case where the second or third utterance reference distance is substituted into the equation (1).

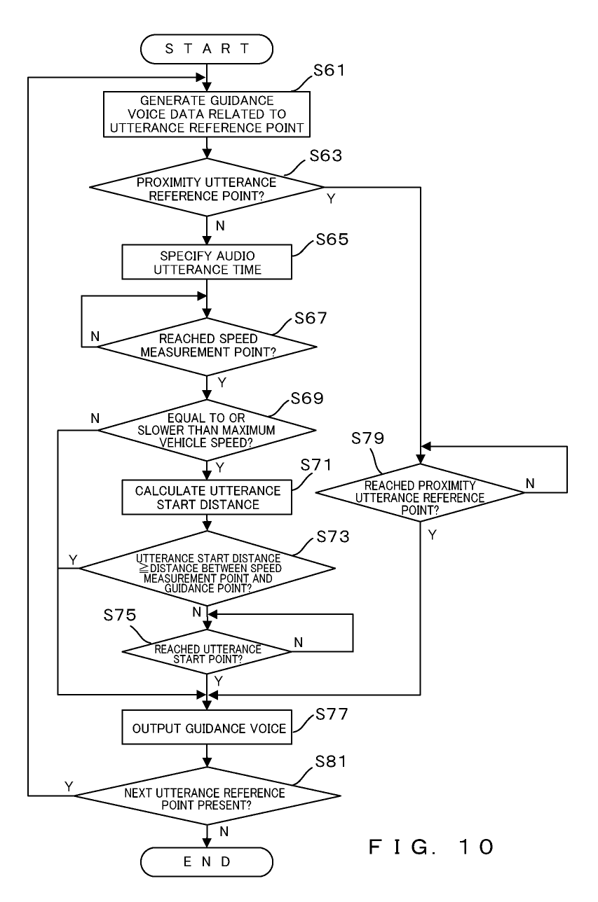

The utterance preparation time in equation (1) is an adjustment value, and represents a time required by the system from satisfaction of the conditions for outputting the guidance voice until the start of the guidance voice utterance by the navigation device (for example, this corresponds to a time from the determination in step S75 in FIG. 10 that the vehicle has reached the utterance start point until the execution of step S77). The utterance preparation time is, for example, approximately 0.1 second. The utterance preparation time is normally a minute value, so it can be deleted from equation (1).

The maximum vehicle speed in equation (1) is a vehicle speed compared to a vehicle speed measured at the speed measurement point as described below, and is a vehicle speed that serves as a reference value for an operation for uttering a guidance voice. In an audio guidance (step S11 in FIG. 2) described in detail later, when the vehicle has reached a speed measurement point and the vehicle speed has been measured, it is determined whether or not that measured speed exceeds the maximum vehicle speed. When the measured vehicle speed exceeds the maximum vehicle speed, the guidance voice is immediately uttered (steps S69 and S77 in FIG. 10). The maximum vehicle speed at a certain speed measurement point differs depending on whether that speed measurement point is on an expressway. The reference speed in the case where the speed measurement point is on an expressway is faster than the reference speed in cases where the speed measurement point is not on an expressway. Also, with the present embodiment, taking into account the fact that in many cases a vehicle reduces its speed when the vehicle has approached a guide point, the maximum vehicle speed set for the first speed measurement point is set to a value smaller than the maximum vehicle speed set for other speed measurement points.

In the present embodiment, the setting values of the maximum vehicle speed for the first to third speed measurement points are stored, for the case of an expressway and the case of a road other than an expressway, in the ROM (7) of the control portion (1) for example (as described above, the setting values for the first to third utterance reference distances, as well as the setting values for the average voice utterance time, utterance preparation time and the like are also stored in the ROM (7) for both of the cases). In addition, the first to third speed measurement distances determined by equation (1) also are calculated in advance for the case of an expressway and the case of a road other than an expressway, and stored in, for example, the ROM (7) of the control portion (1). The control portion (1), when setting a speed measurement point, selects and uses an appropriate speed measurement distance in accordance with the classification of that speed measurement point, based on whether or not the utterance reference point corresponding to that speed measurement point is on an expressway (or, whether or not the section between adjacent guide points between which the utterance reference point is present is on an expressway).

With respect to the example illustrated in FIG. 4, when the first to third speed measurement points PV1 to PV3 are not on an expressway, for example, the maximum vehicle speed for the first speed measurement point PV1 is set to 60 km/h, and the maximum vehicle speed for the second speed measurement point PV2 and the third speed measurement point PV3 is set to 80 km/h. When the first to third speed measurement points PV1 to PV3 are on an expressway, the maximum vehicle speed for the first speed measurement point PV1 is set to 100 km/h, and the maximum vehicle speed for the second speed measurement point PV2 and the third speed measurement point PV3 is set to 200 km/h. For the case of an expressway and the case of a road other than an expressway, first to third speed measurement distances are determined by equation (1) with the use of these maximum vehicle speeds, the first to third utterance reference distances (50 m, 400 m and 1000 m, respectively, for the case of a road other than an expressway, and 120 m, 1000 m, and 2000 m, respectively, for the case of an expressway), average voice utterance time (five seconds) and the utterance preparation time (0.1 second). Note that in the present embodiment, the first to third utterance reference distances and the first to third speed measurement distances are set such that (both in the case of an expressway and the case of a road other than an expressway) third speed measurement distance>third utterance reference distance>second speed measurement distance>second utterance reference distance>first speed measurement distance>first utterance reference distance.

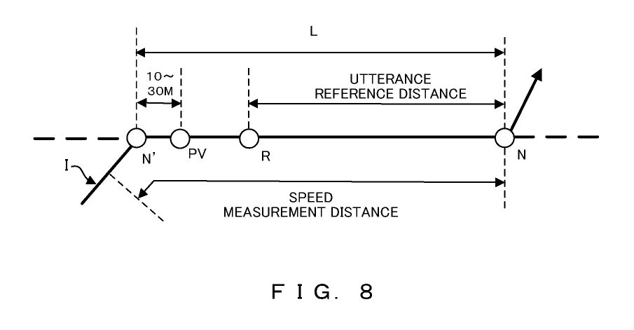

In this manner, the speed measurement point is set for each utterance reference point on the guidance route with the use of the speed measurement distance determined by equation (1). In the present embodiment, a situation may occur in which the speed measurement distance is longer than the distance L between adjacent guide points. FIG. 8 is a diagram illustrating such a situation. In FIG. 8, utterance reference position R is a nearest utterance reference point to the guide point N′ that precedes the guide point N, and can be any of the first to third utterance reference points (steps S25, S29 and S33 in FIG. 5). In steps S23, S27 and S31 in FIG. 5, it is assured that the distance L is longer than the utterance reference distance for the utterance reference position R. Since equation (1) involves an utterance reference distance, the speed measurement distance that determines the speed measurement point corresponding to the utterance reference position R is longer than the utterance reference distance for the utterance reference position R. However, in the cases where the preceding guide point N′ is located near the utterance reference position R, the speed measurement distance can be the distance L or longer as illustrated in FIG. 8.

With the present embodiment, when a speed measurement point corresponding to a certain utterance reference point is set, in the case where the speed measurement distance used in setting the speed measurement point is equal to or longer than the distance between adjacent guide points, the speed measurement point is set to a point obtained by advancing a prescribed distance along the guide route from a guide point that precedes a guide point for which guidance is provided with a guidance voice. In FIG. 8, a point obtained by advancing a prescribed distance (for example, 10 to 30 m) along the guidance route I from the preceding guide point N′ is set as the speed measurement point PV. By setting the utterance reference point in this manner, the utterance reference point and the speed reference point corresponding thereto are assured to be located in the same section that is between adjacent guide points. Note that the preceding guide point can be set as the speed measurement point (in such a case, that speed measurement point is regarded as being in the section that is between adjacent guide points to which the corresponding utterance reference point belongs).

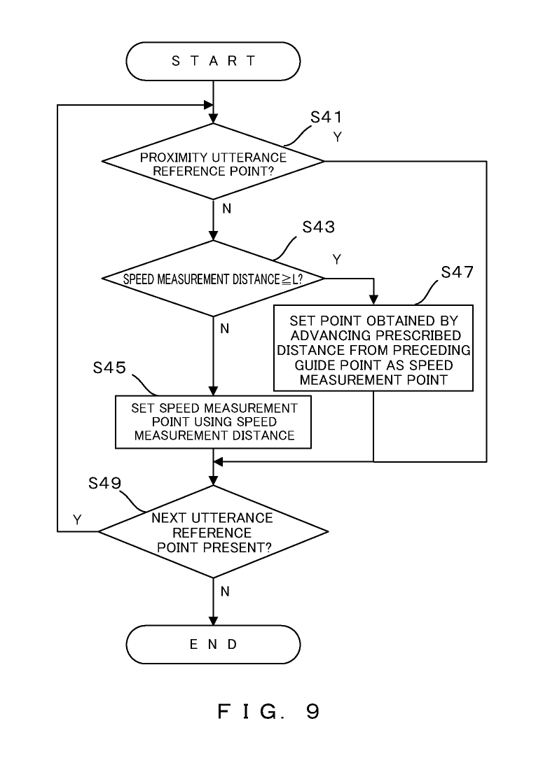

FIG. 9 is a flowchart illustrating a detailed process for setting speed measurement points indicated as step S9 in FIG. 2. The control portion (1) sets speed measurement points in order from the start point to the destination for each utterance reference point on the guidance route. Note that the speed measurement point is not set for the proximity utterance reference point. Initially, the control portion (1) determines, for one of the utterance reference points in the utterance reference point list, whether or not that utterance reference point is the proximity utterance reference point (S41). In step S41, for example, such a determination is made based on the position or guidance details described in the utterance reference point list in FIG. 7.

When the utterance reference point is not the proximity utterance reference point, the control portion (1) determines after step S41 whether or not the speed measurement distance is equal to or longer than the distance L between a guide point corresponding to the utterance reference point and a guide point preceding thereto (S43). When the utterance reference point is the first utterance reference point, the first speed measurement distance and the distance L are compared, when the utterance reference point is the second utterance reference point, the second speed measurement distance and the distance L are compared, and when the utterance reference point is the third utterance reference point, the third speed measurement distance and the distance L are compared. When the utterance reference point is on an expressway, the speed measurement distance for expressway is used, and when the utterance reference point is not on an expressway, the speed measurement distance for a road other than an expressway is used. The results in step S21 in FIG. 5 are used for the value of the distance L and determination as to whether or not the utterance reference point is on an expressway.

When it is determined in step S43 that the speed measurement distance is shorter than the distance L, the control portion (1) sets the speed measurement point on the guidance route based on the speed measurement distance (S45). Information on the set speed measurement point (such as ID number, position, etc.), is added to a speed measurement point list (not shown) stored in the RAM (5). When it is determined in step S43 that the speed measurement distance is equal to or longer than the distance L, the control portion (1) sets the point obtained by advancing a prescribed distance along the guidance route from the preceding guide point as the speed measurement point, as described with reference to FIG. 8 (S47).

After step S41, S43 or S45, the control portion (1) determines whether or not there is another utterance reference point for which the speed measurement point should be set, and when there is another utterance reference point, performs the processing in step S41 onward on that utterance reference point (S49). When the utterance reference point is set for the last utterance reference point, it is determined in step S49 that there remain no utterance reference points, and the process for setting speed measurement points ends.

The utterance start distance is calculated for each utterance reference point by the following equation (2) with the use of the vehicle speed (measured speed) measured at the speed measurement point corresponding to each utterance reference point.

Utterance Start Distance=Utterance Reference Distance+(Voice Utterance Time+Utterance Preparation Time)×Measured Speed Equation (2)

Based on the utterance start distance, the utterance start point, which is a point on the guidance route where outputting a guidance voice is started, is determined, as described above. The utterance reference distance in equation (2) is the utterance reference distance of the utterance reference point, and similarly to equation (1), is any of the first to third utterance reference distances, whose value varies depending on whether or not that utterance reference point is on an expressway. The utterance preparation time is also the same as in equation (1). The voice utterance time in equation (2) is the utterance time of a guidance voice output at the utterance start point (or a guidance voice related to the corresponding utterance reference point). For example, the voice utterance time of equation (2) of the third utterance start point corresponding to the third utterance reference point R2-3 shown in FIG. 3 and FIG. 6 is 3.5 seconds (voice type “2” in FIG. 7), that of the second utterance start point corresponding to the second utterance reference point R2-2 is three seconds (voice type “3” in FIG. 7), and that of the third utterance start point corresponding to the first utterance reference point R2-1 is 2.5 seconds (voice type “4” in FIG. 7).

In the example illustrated in FIG. 4, the first utterance start point PC1 is a point obtained by returning (toward the start point) along the guidance route I from the guide point N by a first utterance start distance calculated by equation (2) with the use of the vehicle speed measured at the first speed measurement point PV1. The second utterance start point PC2 is a point obtained by returning from the guide point N by a second utterance start distance calculated by equation (2) with the use of the vehicle speed measured at the second speed measurement point PV2. The third utterance start point PC3 is a point obtained by returning from the guide point N by a third utterance start distance calculated by equation (2) with the use of the vehicle speed measured at the third speed measurement point PV3. Note that with the present embodiment, a situation may occur in which the utterance start distance obtained for an utterance reference point located on the side of the preceding guide point is equal to or longer than the distance from the speed measurement point corresponding to that utterance reference point to the target guide point. In other words, a situation may occur in which the utterance start point determined by the utterance start distance calculated by equation (2) is located on the side of the start point relative to the speed measurement point (or located in the speed measurement point). In this case, with the present embodiment, a guidance voice is uttered when the vehicle reaches the speed measurement point.

FIG. 10 is a flowchart illustrating details of the audio guidance in step S11 in FIG. 2. In the navigation device, the utterance reference points are arranged in the utterance reference point list prepared in step S7 in the order in which the vehicle will pass through along the guidance route as illustrated in FIG. 6. The control portion (1) refers to the utterance reference point list, and outputs the guidance voices for the guide points on the guidance route with the traveling of the vehicle in the order of the utterance reference points. First, the control portion (1) prepares voice data for a guidance voice related to a certain utterance reference point (S61). The guidance voice is output at the utterance start point corresponding to the utterance reference point (or output at the speed measurement point corresponding to the utterance reference point). When the utterance reference point is the proximity utterance reference point, the guidance voice is output at the proximity utterance reference point. In the case where step S61 is initially executed, voice data for a guidance voice related to the nearest utterance reference point to the start point is generated. The control portion (1) refers to the voice type table and loads voice element data files (29) necessary for the voice type of the target utterance reference point from the recording medium (23), and composes pieces of the voice element data of such loaded voice element data files (29). In the cases where the voice type includes a road name, the control portion (1) refers to the column of the guidance details in the utterance reference point list to specify the road name, and generates voice element data for that road name, and composes the generated data with the voice element data of the voice element data files (29) loaded from the recording medium (23).

After step S61, the control portion (1) determines whether or not the target utterance reference point, namely, the utterance reference point related to the guidance voice to be output is the proximity utterance reference point (S63). When it is determined in step S63 that the utterance reference point is not the proximity utterance reference point, the control portion (1) specifies the voice utterance time of the guidance voice generated in step S61 (S65). The control portion (1) calculates, from the amount of voice data for the guidance voice stored in the RAM (5) for example, the voice utterance time for the guidance voice. In the case where the voice element data file (29) contains a tag with which data reproduction time can be described, it is possible to specify and integrate the utterance time of each voice element constituting the guidance voice, with reference to the tag in the voice element data file (29) related to the guidance voice to be output. As shown in the voice type table in FIG. 7, the voice utterance times that are calculated in advance for the voice types may be referred to, but with respect to the voice types that include a road name, it is necessary to calculate the voice utterance time in step S65. In such a case, the utterance reference point list in FIG. 6 may be referred to so as to calculate the time required for uttering the specified road name, and the calculated time may be added to the time (obtained in advance) required for uttering other voice elements included in the guidance voice.

During the audio guidance in step S11, the control portion (1) periodically calculates the current vehicle position based on the data obtained from the GPS receiver (9), gyroscope (11) and speed sensor (13), and after step S65, the control portion (1) determines whether or not the vehicle has reached the speed measurement point corresponding to the target utterance reference point (S67). In step S67, the control portion (1) specifies the corresponding speed measurement point with the use of the speed measurement point list prepared in step S9, and for example, when the vehicle position enters a prescribed region including the specified speed measurement point, the vehicle is determined to have reached the speed measurement point. Alternatively, when the vehicle position is acknowledged to be in a position that has passed the speed measurement point on the guidance route, the vehicle is determined to have reached the speed measurement point.

When it is determined in step S67 that the vehicle has reached the speed measurement point, the control portion (1) stores the vehicle speed based on the data obtained from the speed sensor (13), and also determines whether or not the measured speed is equal to or slower than a maximum vehicle speed (S69). As described above, depending on whether or not the speed measurement point is on an expressway and the classification of the speed measurement point (first to third speed measurement points), the maximum vehicle speed varies. In step S69, a maximum vehicle speed that corresponds to the feature of the speed measurement point that the vehicle has reached and the measured vehicle speed are compared. In the above example, in the case where the speed measurement point is a first speed measurement point on a road other than an expressway, a maximum vehicle speed of 60 km/h and the measured vehicle speed are compared, and in the case where the speed measurement point is a third speed measurement point on an expressway, a maximum vehicle speed of 200 km/h and the measured vehicle speed are compared.

When it is determined in step S69 that the measured vehicle speed is equal to or slower than the maximum vehicle speed, the control portion (1) calculates the utterance start distance for the target utterance reference point by equation (2) with the use of the vehicle speed measured in step S69 (S71).

The utterance reference distance for the target utterance reference point is used for the utterance reference distance in equation (2). After step S71, the control portion (1) determines whether or not the utterance start distance calculated in step S71 is equal to or longer than the distance between the speed measurement point that the vehicle was determined to have reached in step S67 and the guide point that the vehicle is to pass through next (guide point where audio guidance is provided with the use of guidance voice data generated in step S61) (S73). In step S73, in addition to the utterance start distance calculated in step S71, the guidance route information obtained in step S3, the guide point extraction results obtained in step S5, the speed measurement point list obtained in step S9 or the like are used to make the determination. In the case where the speed measurement point that the vehicle was determined to have reached in step S67 is the speed measurement point set in step S45 in FIG. 9, the calculated utterance start distance and the speed measurement distance for that speed measurement point are compared. In the case where that speed measurement point is the speed measurement point set in step S47 in FIG. 9, the calculated utterance start distance and a value obtained by subtracting a prescribed distance (10 m to 30 m) from the distance L between the adjacent guide points (between which that speed measurement point is present) are compared.

In the case where the utterance start distance calculated in step S71 is shorter than the distance between the speed measurement point that the vehicle was determined to have reached in step S67 and the guide point that the vehicle is to pass through next, after step S73, the control portion (1) determines, similarly to step S67, whether or not the vehicle has reached the utterance start point specified based on the utterance start distance calculated in step S71 (S75). The control portion (1) specifies the utterance start point with the use of the utterance start distance calculated in step S71, the guidance route information obtained in step S3, guide point extraction results obtained in step S5 or the like. When it is determined in step S75 that the vehicle has reached the utterance start point, the control portion (1) transmits voice data generated in step S61 to the audio output portion (19) and provides an instruction to output the same (S77).

When it is determined in step S69 that the vehicle speed exceeds the maximum vehicle speed, step S77 is immediately executed. With the navigation device of the present embodiment, delay in outputting the guidance voice is suppressed by performing such processing in the case of a very high vehicle speed. Also, in the case where the utterance start distance calculated in step S71 is determined in step S73 to be equal to or longer than the distance between the speed measurement point that the vehicle was determined to have reached in step S67 and the guide point that the vehicle is to pass through next, step S77 is immediately executed so that the guidance voice is output at the speed measurement point. In this manner, a guidance voice related to the target utterance reference point is reliably uttered.

When it is determined in step S63 that the target utterance reference point is the proximity utterance reference point, the control portion (1), similarly to step S67, determines whether or not the vehicle has reached the proximity utterance reference point as the utterance reference point (S79). When it is determined in step S79 that the vehicle has reached the proximity utterance reference point, step S77 is immediately executed. Accordingly, the audio guidance is provided for a guide point even in a situation in which the distance between adjacent guide points is extremely short. Note that in step S77 executed after step S79, the guidance voice may be output when the vehicle has advanced a prescribed distance (for example, 10 m to 30 m) from the preceding guide point (proximity utterance reference point).

After step S77, the control portion (1) determines whether or not there is a next utterance reference point, in the utterance reference point list, that is on the destination side relative to the utterance reference point relating to the guidance voice output in step S77 (S81), and when there is a next utterance reference point, step S61 onward are executed again for that next utterance reference point. When guidance voices have been output for all utterance reference points, specifically, when a guidance voice has been output for the nearest utterance reference point to the destination, the audio guidance in step S11 ends.

In an audio guidance operation of the foregoing embodiment, for example, a guidance voice related to the second utterance reference point R2-2 shown in FIG. 3 and FIG. 6 is uttered as described below. The second speed measurement distance, namely, the second speed measurement point corresponding to the second utterance reference point R2-2 is determined by equation (1). The second utterance reference distance is 400 m, and the maximum vehicle speed is 80 km/h. Assuming that the average voice utterance time is five seconds, and the utterance preparation time is 0.1 second, the second speed measurement distance is determined by equation (1) as 400+(5+0.1)×80×1000÷3600=513 m. That is, the point obtained by returning along the guidance route I from the guide point corresponding to node N2 shown in FIG. 3 by 513 m is the second speed measurement point related to that guide point.

When the vehicle reaches the aforementioned second speed measurement point, the control portion (1) obtains the vehicle speed from the data of the speed sensor (13). The control portion (1), in the case where the obtained speed exceeds the maximum vehicle speed, 80 km/h, transmits to the audio output portion (19) voice data for the guidance voice of the voice type “3” in FIG. 7, “Turn right in 400 m”, and also instructs the audio output portion (19) to output the guidance voice from the speaker (21). In the case where the vehicle speed at the second speed measurement point is equal to or slower than 80 km/h, the control portion (1) calculates the second utterance start distance so that the second utterance start point is set. When the measured vehicle speed is 60 km/h, for example, the utterance time of the voice type “3” is three seconds, and thus the second utterance start distance is determined by equation (2) as 400+(3+0.1)×60×1000÷3600=452 m. That is, the point obtained by returning along the guidance route I from the guide point corresponding to node N2 shown in FIG. 3 by 452 m is the second utterance start point for that guide point. When the vehicle reaches the second utterance start point, the control portion (1) provides an instruction to the audio output portion (19) so that the guidance voice of the voice type “3” is output from the speaker (21), whose utterance continues for three seconds. When the vehicle speed is kept at 60 km/h without change, the distance that the vehicle moves during the three seconds is 60×1000÷3600×3=50 m. In conclusion, uttering the guidance voice of the voice type “3”, “Turn right in 400 meters” completes substantially at the same time that the vehicle reaches the utterance reference point R2-2, that is located 400 m short of the guide point corresponding to node N2.

Also, for example, the guidance voice related to the second utterance reference point R5-2 shown in FIG. 6 is uttered as described below. The second speed measurement distance, namely, the second speed measurement point is determined by equation (1), and similar to the foregoing example, the second speed measurement distance is determined as 513 m, and the point obtained by returning along the guidance route I from the guide point corresponding to node N5 shown in FIG. 3 by 513 m is the second speed measurement point related to that guide point. When the vehicle speed calculated at the second speed measurement point is 60 km/h, for example, the utterance time of the voice type “25” is six seconds, and thus the second utterance start distance is determined by equation (2) as 400+(6+0.1)×60×1000+3600=502 m. That is, the point obtained by returning along the guidance route I from the guide point corresponding to node N5 shown in FIG. 3 by 502 m is the second utterance start point for that guide point. When the vehicle reaches the second utterance start point, the guidance voice of the voice type “25” is output, with this utterance continuing for six seconds. When the vehicle speed is kept at 60 km/h without change, the distance that the vehicle moves during the six seconds is 60×1000÷3600×6=100 m. In conclusion, uttering the guidance voice of the voice type “25”, “Turn left in 400 m onto the entrance to the expressway” ends substantially at the same time that the vehicle reaches the utterance reference point R5-2, which is located 400 m short of the guide point corresponding to node N5.

With the navigation device of the present embodiment, an operation for displaying a guidance screen including a map around the current vehicle position on the display portion (17) is also performed, in parallel with the audio guidance operation illustrated in detail in FIG. 10. Although such an operation is not described in detail since it is not directly involved in the present invention, the travel distance until the guidance screen that the vehicle is to pass through next (the nearest guide point along the guidance route) is displayed in the display portion (17) in real time on the guidance screen. The displayed travel distance has a value close to the utterance start distance calculated in step S71 when it is determined that the vehicle has reached the utterance start point in step S75, for example. With the navigation device of the present embodiment, output of the guidance voice is controlled as described above. As a result, the vehicle passes through the utterance reference point approximately at the point in time when step S77 is completed and the outputting the guidance voice ends. The displayed travel distance of the navigation device has a value close to the utterance reference distance substantially at the point in time when outputting the guidance voice completes, and therefore with the navigation device of the present embodiment, the point in time when notification of the utterance reference distance by the guidance voice completes and the point in time when the utterance reference distance is displayed on the display portion (17) substantially match.

With the navigation device of the present invention, the utterance start distance may be obtained by an equation other than the above-mentioned equation (2). For example, the utterance preparation time in equation (2) can be omitted since it has a minute value when the control portion (1) performs high-speed processing. In the present invention, the utterance start point is required to be set further away from the guide point or the utterance reference point the longer voice utterance time, and therefore the relationship between the utterance start distance and the voice utterance time is defined such that the utterance start distance increases the longer voice utterance time. Also in the present invention, the utterance start point is required to be set further away from the guide point or the utterance reference point as the measured speed increases, and therefore the relationship between the utterance start distance and the voice utterance time is defined such that the utterance start distance increases as the measured speed increases. Since the distance is obtained by multiplying time and speed, and furthermore, due to the utterance start distance needing to be longer than the utterance reference distance, it is normal that mathematical description or operation for the utterance start distance includes a sum of a product of voice utterance time and vehicle speed and the utterance reference distance.

With the navigation device of the present invention, a maximum voice utterance time, which is the utterance time of the longest guidance voice, may be used instead of the average voice utterance time in the above equation (1). Also, with the navigation device of the present invention, the voice utterance time of the guidance voice output at the utterance start point corresponding to the target speed measurement point may be used instead of the average voice utterance time of the above equation (1). In this case, a process is necessary prior to step S43 in FIG. 9 for specifying the voice utterance time of the guidance voice related to the target utterance reference point, and calculating the speed measurement distance with the use of the specified voice utterance time. Note that in the foregoing embodiments, equation (1) is merely an example of a method for determining the speed measurement distance or speed measurement point.

The GPS receiver (9), or the GPS receiver (9), gyroscope (11) and speed sensor (13) in the foregoing embodiments correspond to position locating means in the present invention. The speed sensor (13) in the foregoing embodiments corresponds to speed measurement means in the present invention. The audio output portion (19) and speaker (21) in the foregoing embodiments correspond to audio output means in the present invention. The control portion (1) and the program (27) executed therein in the foregoing embodiments correspond to control means in the present invention. In the foregoing embodiments, while specific values are described with respect to the number of the utterance reference points, the vehicle speed, duration of voices or set distances, it should be noted that these values are merely given as examples for the purpose of description.

The description of the foregoing embodiments is for illustrating the present invention, and should not be understood as limiting the invention disclosed in the claims or as restricting the scope of the invention. The constituent elements of the present invention are not limited to the foregoing embodiments, and can, of course, be modified within the technical scope of the invention disclosed in the claims.

1. A navigation device comprising:
position locating means for locating a position of a vehicle;
speed measurement means for measuring a speed of the vehicle;
audio output means for outputting a guidance voice related to a guide point on a guidance route leading to a destination; and
control means for controlling output of the guidance voice by using as reference a reference point obtained by returning along the guidance route from the guide point by a prescribed reference distance,
wherein the control means calculates an utterance start distance when the vehicle reaches a speed measurement point on the guidance route set with respect to the reference point, and causes the audio output means to output the guidance voice when the vehicle reaches an utterance start point obtained by returning along the guidance route from the guide point by the utterance start distance, and
the utterance start distance is longer than the reference distance, and increases as a duration of the guidance voice increases, and as the vehicle speed at the speed measurement point increases.

2. The navigation device according to claim 1, wherein the utterance start distance is determined by an operation that includes adding the reference distance to a product of the duration of the guidance voice and the vehicle speed at the speed measurement point.

3. The navigation device according to claim 2, wherein the utterance start distance is a value obtained by adding the reference distance to a product of a sum of a prescribed adjustment value and the duration of the guidance voice and the vehicle speed at the speed measurement point.

4. The navigation device according to claim 1, wherein the reference distance in a case where the reference point is on an expressway is longer than the reference distance in a case where the reference point is on a road other than an expressway.

5. The navigation device according to claim 1, wherein the control means, in a case where the vehicle speed at the speed measurement point is faster than a prescribed reference speed, causes the audio output means to output the guidance voice at the speed measurement point.

6. The navigation device according to claim 5, wherein the reference speed in a case where the speed measurement point is on an expressway is faster than the reference speed in a case where the speed measurement point is on a road other than an expressway.

7. The navigation device according to claim 1, wherein the control means, in a case where the utterance start distance is equal to or longer than a distance from the speed measurement point to the guide point along the guidance route, causes the audio output means to output the guidance voice at the speed measurement point.

8. A navigation device comprising:
position locating means for locating a position of a vehicle;
speed measurement means for measuring a speed of the vehicle;
audio output means for outputting one or more guidance voices for a guide point on a guidance route leading from a start point to a destination; and
control means for controlling output of the one or more guidance voices based on the position of the vehicle and the speed of the vehicle,
wherein the one or more guidance voices are respectively related to one or more reference points on the side of the start point relative to the guide point on the guidance route,
one or more speed measurement points are respectively set for the one or more reference points, on the side of the start point relative to the guide point,
the control means, when the vehicle reaches each of the one or more speed measurement points, calculates an utterance start distance with use of the vehicle speed measured at the speed measurement point, and when the vehicle reaches an utterance start point obtained by returning along the guidance route from the guide point by the utterance start distance, causes the audio output means to output the guidance voice related to the reference point corresponding to the speed measurement point, and
the utterance start distance is longer than the reference distance from the reference point corresponding to the speed measurement point that the vehicle has reached to the guide point along the guidance route, and increases as a duration of the guidance voice related to the reference point increases and as the measured vehicle speed increases.

9. The navigation device according to claim 8, wherein except for a case in which the utterance start point is an utterance start point that is nearest to the guide point, a guidance voice including notification of the reference distance of the reference point corresponding to the speed measurement point where the vehicle speed used in calculating the utterance start distance was measured is output at the utterance start point.

10. The navigation device according to claim 8, wherein the utterance start distance is determined by an operation that includes adding the reference distance of the reference point corresponding to the speed measurement point where the vehicle speed used in calculating the utterance start distance was measured to a product of the duration of the guidance voice related to the reference point and the measured vehicle speed.

11. The navigation device according to any of claim 8, wherein the reference distance of each of the one or more reference points differs depending on whether or not the reference point is on an expressway, and the reference distance of the reference point if located on an expressway is longer than the reference distance of the reference point if located on a road other than an expressway.

12. The navigation device according to any of claim 8, wherein the control means, in a case where the vehicle speed measured at one of the one or more speed measurement points is faster than a prescribed reference speed, causes the audio output means to output the guidance voice related to the reference point corresponding to the speed measurement point at the speed measurement point.

13. The navigation device according to claim 12, wherein the reference speed is not the same for all of the one or more speed measurement points, and the reference speed for a speed measurement point that is nearest to the guide point is the slowest.

14. The navigation device according to claim 12, wherein the reference speed, for each of the one or more speed measurement points, differs depending on whether or not the speed measurement point is on an expressway, and the reference speed in the case where the speed measurement point is on an expressway is faster than the reference speed in the case where the speed measurement point is on a road other than an expressway.
